(19) United States
(12) Patent Application Publication
(10) Pub. No.: US 2005/0241546 A1
(43) Pub. Date: Nov. 3, 2005

(54) Trailer hitch mounted table and umbrella support apparatus

(76) Inventor: George F. Royse, Cerritos, CA (US)

Correspondence Address: FULWIDER PATTON LEE & UTECHT, LLP, 200 OCEANGATE, SUITE 1550, LONG BEACH, CA, 90802, US

(21) Appl. No.: 10/831,451

(22) Filed: Apr. 22, 2004

(51) Int. Cl. A47B 23/00; A47B 37/00; B60F 1/00; B60R 9/00; B60R 11/00

(52) U.S. Cl. 108/44; 224/521

(57) ABSTRACT

A umbrella and table support including telescopical tubes projecting rearwardly from a trailer hitch receiver, a vertically projecting sleeve at the rear extremity of such tubes, a collar telescopically received on such sleeve and supporting the rear extremity of a large table top from a support plate, the forward extremity being carried on a horizontal surface of the vehicle mounting the hitch receiver.

### BACKGROUND OF THE INVENTION

1. Field of the Invention

The present invention related to a support device for attachment to a vehicle trailer hitch for supporting a shade umbrella in an upright position and while supporting the rear extremity of a tabletop supported as a front extremity from the rear bumper of the vehicle.

2. General Background and State of the Art

With the fast paced life of present day society, leisure time become more and more important. With congestion in the metropolitan and urban areas, outdoor activity has grown in appeal for vacationers involved in recreational activity. Such outdoor activity may be in the form of camping at camp sites, participating as what is known as “tailgating” parties or just everyday picnics where groups come together to enjoy relaxation, food, beverage and recreational activity such as dining, athletic contests or just relaxing.

Popular forms of transportation include sport utility vehicle, pick ups, station wagons and RV's which often include trailer hitches for trailering a boat, motorcycle, all terrain vehicle or other recreational devices.

Often times it is desirable to locate some shade to protect the participants from the sun, particularly during day and mid day activity and late afternoon relaxation. It is also desirable to have a large surface area for supporting dining bowls, plates, utensils and sometimes recreational paraphernalia. It has thus long been recognized that it is desirable to support a shade umbrella, small service tables or even chairs from a vehicle trailer hitch.

Various different fixtures and devices have been proposed for mounting umbrellas, small tables, chairs, or barbeque devices from a trailer hitch. Examples are shown in U.S. Pat. No. 5,397,147 to Ducharme, U.S. Pat. No. 5,857,741 to Anderson, U.S. Pat. No. 5,950,617 to Lorenz, U.S. Pat. No. 6,082,269 to Padberg and U.S. Pat. No. 6,189,458 to Rivera. These devices are typically cantileverally mounted from a trailer hitch and support a relatively small table and umbrella in an elevated position.

It also has been proposed to mount an umbrella from a trailer hitch fixture wherein such that the umbrella post is supported on the ground and wherein the fixture is articulated so that an arm can be swung around an arc to position the umbrella in various locations relative to the extended longitudinal center line of the vehicle. A device of this type is shown at website www.gatershader.com. However, these prior art devices typically fail to provide a support fixture which will conveniently support a shade umbrella while, at the same time, providing a large surface table for family dining or recreational activity requiring substantial space and/or paraphernalia and equipment.

### INVENTION SUMMARY

The present invention is characterized by rigid telescopical tubes connected at their forward extremity to a trailer hitch of a vehicle and projecting rearwardly there from to support at the rearward extent, a vertical through sleeve for telescopical receipt of an umbrella post to extend there through and be supported on its bottom end from the ground. Mounted over such sleeve is a table support collar carrying a horizontal plate disposed in the horizontal plane of the vehicle rear bumper or tailgate to receive and mount the rear extremity of a large table top.

Text

### BRIEF DESCRIPTION OF THE DRAWINGS

FIG. 1 is a perspective view showing a umbrella and table support apparatus of the embodiment of the present invention;

FIG. 2 is a partial side view, in a large scale, of the apparatus shown in FIG. 1;

FIG. 3 is a horizontal sectional view, in reduced scale, taken along the lines 3-3 of FIG. 2;

FIG. 4 is a vertical sectional view, in a large scale, taken along the lines 4-4 of FIG. 3;

FIG. 5 is a horizontal sectional view, in a large scale, taken along the lines 5-5 of FIG. 2;

FIG. 6 is a horizontal sectional view, in a large scale, taken along the lines 6-6 of FIG. 2;

FIG. 7 is a vertical sectional view, in a large scale, taken along the lines 7-7 of FIG. 2;

FIG. 8 is a perspective view of a second embodiment of an umbrella and table support apparatus of the present invention;

FIG. 9 is a side view, in a large scale, of the apparatus shown in FIG. 8;

FIG. 10 is a top plan view of a third embodiment of the umbrella and table support apparatus of the present invention;

FIG. 11 is a top plan view of the apparatus shown in FIG. 10 but with the table top reversed;

FIG. 12 is a perspective view, in a large scale, of a table support plate included in the apparatus shown in the FIG. 10;

FIG. 13 is a partial top plan view of the apparatus shown in FIG. 10 and depicting the table support plate in broken lines;

FIG. 14 is a vertical sectional view, in a large scale, taken along the lines 14-14 of FIG. 13.

### DETAILED DESCRIPTION OF THE PREFERRED EMBODIMENTS

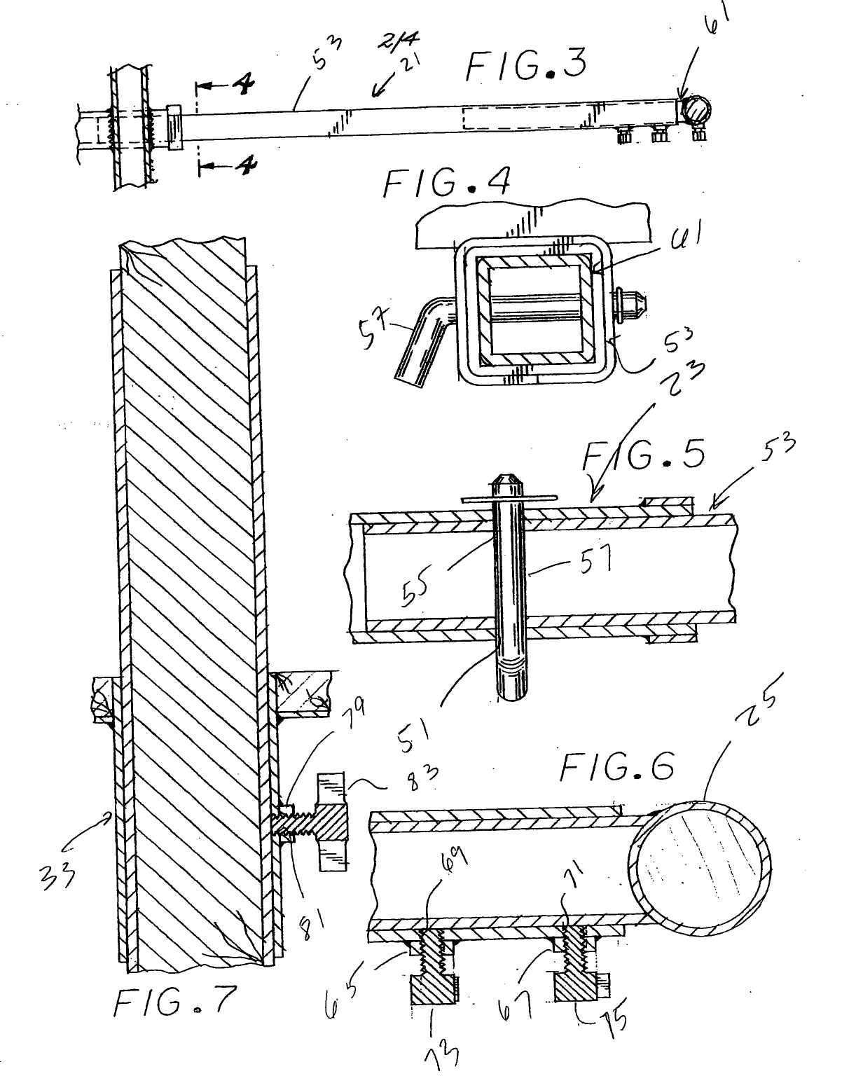

Referring to FIGS. 1-3 the apparatus of the present invention includes, generally, a rigid, longitudinally telescopical frame 21 including a forward extremity received within a trailer hitch receiver 23 and a rearward most extremity mounting a vertical umbrella post sleeve 25 which slidably receives an umbrella post 27 supported at its bottom end 29 on the ground 31. Telescoped over the top end of the sleeve 25 is a tubular collar 33 which includes a adjustment thumb screw 35 to adjust the longitudinal positioning thereof on the collar 25 and mounts its top extremity a table mounting plate 37 on which the rear extremity of a table top generally designated 41 is received. The forward extremity of the top 41 rests on the bumper 43 or possibly on a tailgate or the like.

Outdoor recreation demands comfort and convenience. Often times great enjoyment is derived from visiting outdoor sites, frequently traveling in a SUV, pick up or other vehicle. Whether the outing be just for family recreation, fishing, hunting or just dining and entertaining before or after a sports event, it is desirable during daytime activity to protect the participants from direct sunlight, particularly during mid-day and late afternoon. There is also great demand for a readily accessible large table top for food and service ware. It is this purpose to which the present invention is directed. Table tops on the order of 24″×36″ to 48″ inches are desirable to provide ample surface area for entertaining large families and their guests. It is desirable in some instances to have multiple tables which might be supported in stacked relationship as will be discussed hereinafter.

Modern day hitches include receivers 23 typically have an interior rectangular cross-section on the order of 1¼″ to 2″ inches square. The hitches 23 on many vehicles are positioned approximately 10″ to 12″ inches below the top surface of the bumper 43. The present invention takes advantage of this configuration to provide stable and secure umbrella support and sturdy support of a large table top 41.

Referring to FIG. 5, the hitch receiver 23 is formed centrally along its length with a through bore 51 and receives the front extremity of a female tube 53 of the frame 21 telescopically there into. The male tube is formed with a through bore 55 which aligns with the bore 51 and receives a mounting pin 57 for locking tube 53 in the position shown.

Received telescopically into the rear extremity of the female square tube 53 is a square tube, generally designated 61 which is welded to the rear extremity thereof the lower end of the vertical umbrella post 25 (FIG. 6). Welded in spaced relationship along one side of the female tube 53 are a pair of adjustment nuts 65 and 67 (FIG. 6) which are aligned with a pair of bores 69 and 71 such that respective T-screws 73 and 75 can be screwed therein to abut the side wall of the male tube 61 to set the longitudinal adjustment thereof with respect to the tube 53.

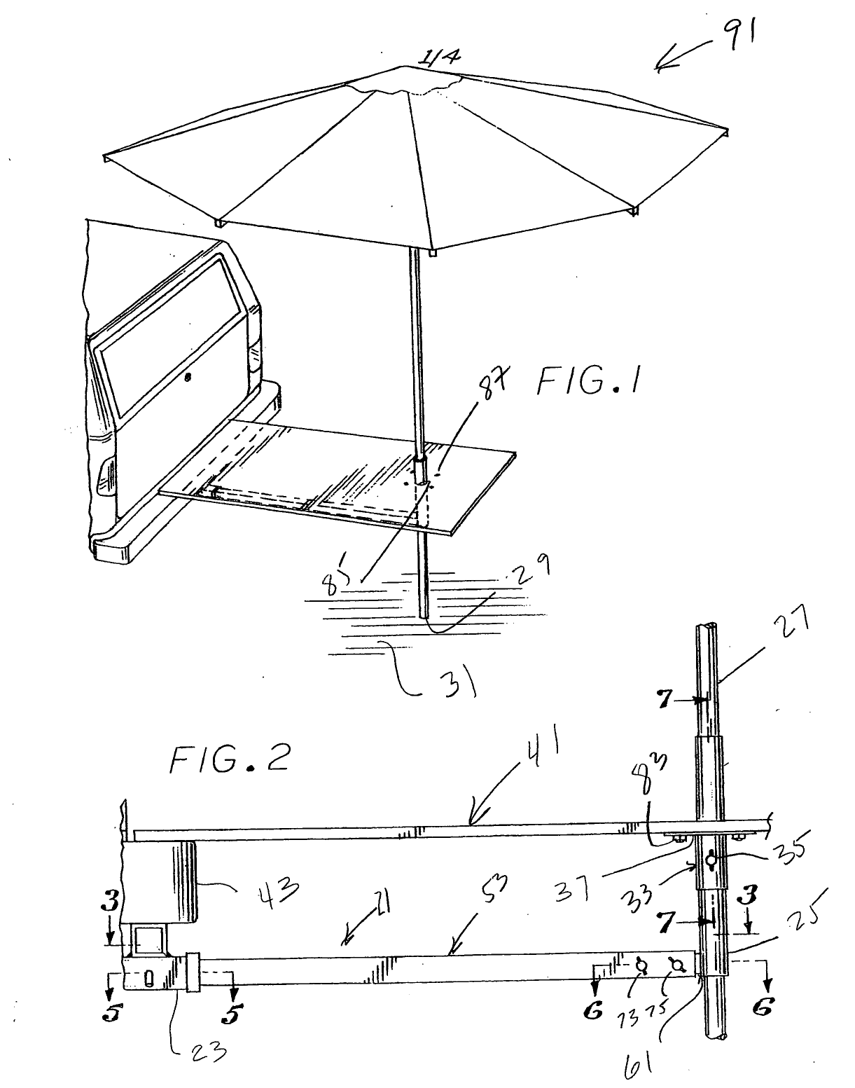

Referring to FIGS. 2 and 7, telescoped over the sleeve 25 is the collar 33 with the table support plate 37 being formed with a through bore for receipt of such collar to be welded thereto as shown in FIG. 7. Welded to the wall of such collar 33 is an adjustment nut 79 aligned with a through bore 81 in the wall of such collar and receiving the threaded stem of a T adjustment screw 83 which to abut the wall of such sleeve to hold the plate 37 in its elevated position for supporting the rear extremity of the table.

Referring to FIG. 12, the plate 37 is square in plan view and formed near the comers with respective bores 81 for receipt of mounting bolts 83 (FIG. 2).

The table top 41 may be about 44″ by 48″ inches and is configured at its rear extremity with a large bore 85 for receipt of the collar 33 and has spaced thereabout, four bolt receiving bores 87 aligned with the bores 81 of the plate 37.

An umbrella generally designated 91 may be of the classical style and may have a large diameter canopy. The posts 27 is 7½ feet long and is about 1¾″ diameter to provide a sturdy support in close fit relationship in the sleeve 25.

In practice, the tube 61 may be telescoped into the tube 51 and the apparatus stored in the vehicle separate from the umbrella. The umbrella may be collapsed and likewise stored in the vehicle and the table top 41 stored likewise possibly received slidably underneath the seats.

When the vehicle reaches its destination and a parking location is selected, the frame 53 may be grasped and removed from the vehicle. The forward extremity of the tube 53 may be slid telescopically into the receiver 23 and the pin 57 inserted to hold it in position (FIG. 5). The T-screw 73 and 75 may be loosened and male tube 61 adjusted to the desired longitudinal dimension. The front extremity of the table top 41 may be rested on the top of the bumper 43 and the collar 33 slide downwardly over the top end of the sleeve 25 while the frame 53 is supported cantileverly from hitch receiver 23. The T-screw 35 in the collar 35 may be tightened to hold the collar 33 in the desired telescopical relationship to support the table tops in a substantially horizontal plane. The umbrella post 27 may then be inserted slidably downwardly from the top end of the sleeve 25 to position the bottom end 29 thereof in resting relationship on the ground 31. This will serve to cooperate with the frame 53 and table top 41 to hold the overall construction in fixed rigid relationship thereby providing sturdy support for the table top 41 and such frame.

Then, as cooking utensils, serving dishes, beverage containers and place settings are taken from the vehicle they can be placed on and about the table top 41 to be supported thereby, all within the shade and protection afforded by the umbrella canopy. The vacationers may then go about entertaining themselves, all with ready access to shade and food and beverage within ready reach.

When picnic or vacation site is to be evacuated, the users may easily withdraw the umbrella post 27 from the sleeve 25 to collapse the umbrella. The T-screw 35 may be unscrewed and the collar 33 lifted off the sleeve 25 to free the table top 41 for storage. The pin 57 may then be removed and the frame 53 withdrawn from the receiver 23 and stored in the vehicle for transport home.

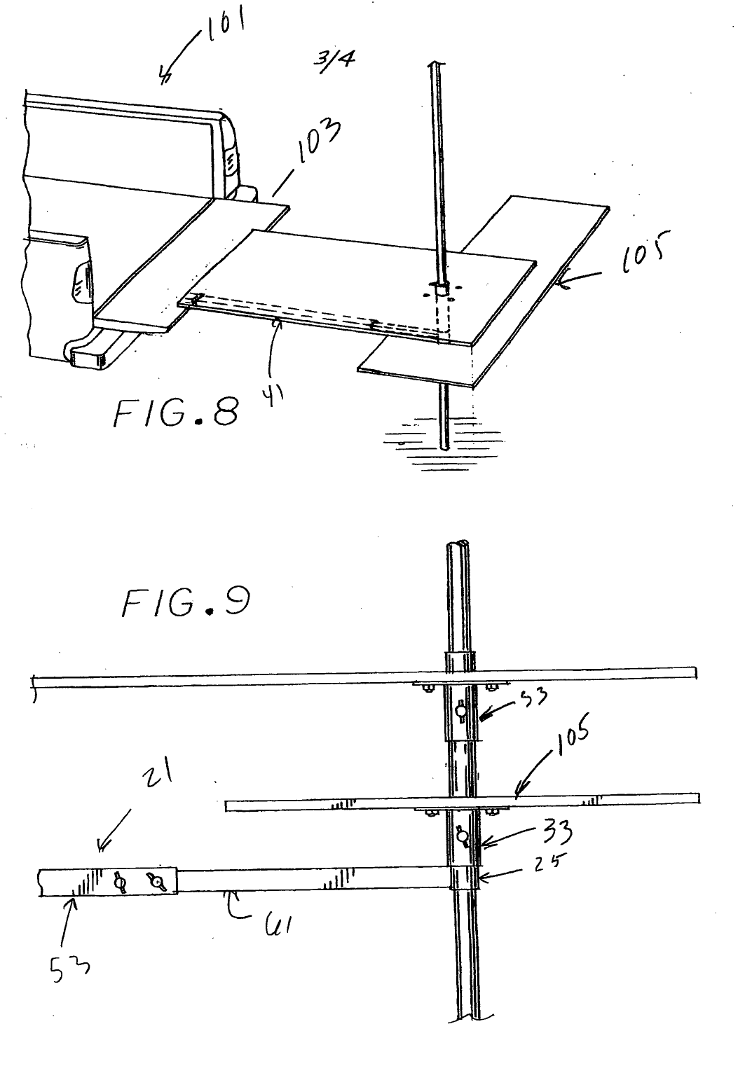

The embodiment shown in FIGS. 8 and 9 is similar to that shown in FIGS. 1-7. In this arrangement, the male tube 61 is telescoped further rearwardly from the female tube 53 to create a longer longitudinal span positioning the sleeve 25 further rearwardly for gaining greater longitudinal surface area for service and recreational purposes. In this illustration, the vehicles in the form of a pick up 101 having a tailgate 103 that is lowered to receive the forward extremity of the table top 41 disposed about 10″ inches rearward of the rear bumper. In this configuration, the table support collar 33 is lowered to engage, in butting relationship the top side of the table support collar 33 of a table top 105 is lowered so that the bottom end thereof abuts the top side of the male tube 61. The table 105 may be oriented in one of a number of different selected positions, as for instance, projecting generally perpendicular to the longitudinal table top 41 as shown in FIG. 8. The support collar 33 of the table top 41 is, however, positioned higher up on the sleeve 25 to position the rear end of the table 41 in an elevated position in substantially the same horizontal plane as the tailgate 103. In this manner, the user gains the advantages of additional table surfaces for different activities, such as for one to act, as a serving table and the other one as a seating table or, possibly serve children at the lower table top 105 and adults at the elevated table top 41.

It will appreciated that operation of the apparatus shown in FIGS. 8 and 9 is substantially the same as that for the apparatus shown in FIGS. 1-7 assembly and disassembly is quite similar and allows for quick and convenient erection at the picnic site and quick disassembly thereof.

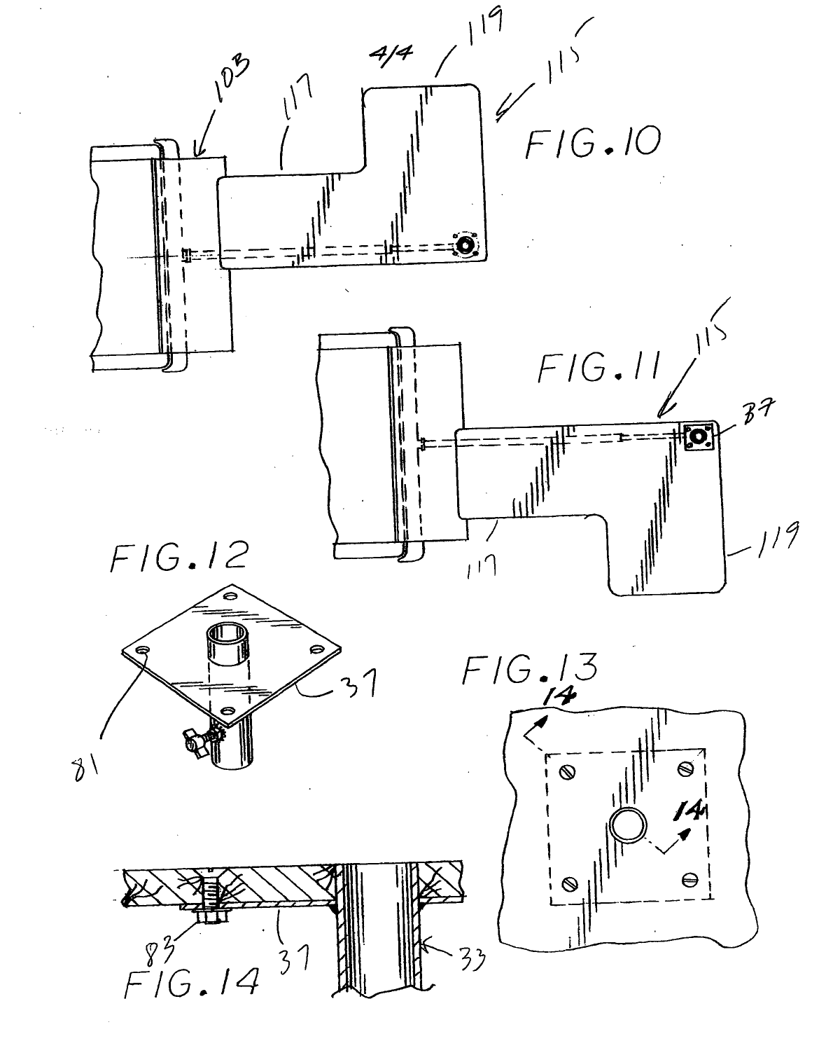

Referring now to the third embodiment of the apparatus of the present invention as shown in FIGS. 10 and 11, there is an L shaped table top, generally designated 115, which might be supported at the front extremity thereof from the tailgate 103 and may be configured with a longitudinal apron 117 and a side return 119. In the configuration shown in FIG. 10, the return 119 projects to the right-hand side as viewed in the orientation of the pick up driver and leaves an L shaped opening which might be approached by a user. This configuration has been found quite advantageous for rifleman utilizing the table top 115 to support their rifles or shotguns during target practice. That is, a left-handed rifleman can sit or stand within the recess forward of the return 119 with his or her elbow on the return 119 and aim generally laterally to the left-hand direction of the vehicle.

In an alternative configuration, the table top 115 might be inverted with the support plate 37 on the top thereof as shown in FIG. 11 thus directing the return 119 to the left-hand side of the vehicle. In this configuration, a right-handed rifleman can easily rest his or her elbow on the return 119 and aim at targets located some distance to the right-hand side of the vehicle.

From the foregoing, it will be appreciated that the umbrella and table support apparatus of the present invention provides a sturdy, inexpensive, convenient support for a table and umbrella. The device is inexpensive to manufacture and is convenient to assemble and disassemble.

While the specification describes particular embodiments of the present invention, those of ordinary skill can devise variations of the present invention without departing from the inventive concept.

1. Hitch mounted table umbrella support apparatus for mounting from the trailer hitch receiver of a vehicle including a bumper or tailgate and comprising:
frame means connectable on its forward extremity with the hitch receiver and including longitudinal means for adjusting the length thereof;
vertically sleeve means mounted at the rear extremity of the frame means for receipt there through of an umbrella post;
table support means mounted on the sleeve means:
adjustment means for adjusting the table support means to different heights depending on the height of the bumper or tailgate of the vehicle; and
table top means mounted at its rear extremity from the table mounting means and projecting forwardly to rest on the bumper or tailgate.

2. The support apparatus of claim 1 wherein:
the collar is formed with a bore in the wall thereof and mounts a threaded nut; and
the adjustment means includes a screw threaded and received in such nut for engaging the sleeve.

3. The support apparatus of claim 1 that includes:
an adjuster for locking the position of the male tube relative to the female.

4. The apparatus of claim 1 wherein:
the table top means is substantially 2 feet wide and 3 feet long.

5. The support apparatus of claim 1 wherein:
the table support means includes a plurality of mounting bores spaced thereabout; and
the table top means a plurality of mounting bores arranged to mate with the first mentioned mounting bores.

6. The support apparatus of claim 1 wherein:
the table top means includes a bore there through for slidable receipt of the sleeve.

7. The support apparatus of claim 1 that includes:
second table support means for receipt over the sleeve means plate; and
a second table top supported by the second table support means.

8. The support apparatus of claim 1 wherein:
the table top means includes a longitudinally projecting apron and a laterally projecting return.

9. The support apparatus of claim 1 for mounting from a vehicle having a bumper disposed at a predetermined height and wherein;
the sleeve means projects upwardly a sufficient distance to support the table support means and substantially the predetermined height.

10. The support apparatus of claim 1 for use with a vehicle having a tailgate disposed at a predetermined height and wherein:
the sleeve means projects upwardly a sufficient distance to position the table support means substantially the predetermined height.

11. The table umbrella support apparatus for mounting from a vehicle with a trailer hitch receiver and comprising:
a square female tube received on its forward extremity in the hitch receiver and projecting rearwardly therefrom;
a square male tube received slidably into the rear extremity of the female tube;
a hitch fastener for fastening the female to the receiver;
a male tube being formed in one wall with a pair of longitudinally spaced bores;
bolt nuts mounted on the wall over the bores;
adjuster screws received threadably in the nuts to, upon being screwed inwardly, engaged the wall of the male tube;
a sleeve projecting vertically upward from the rear extremity of the male tube for receipt of an umbrella post;
a tubular collar slidably received over the top extremity of the sleeve, the collar formed in its wall with a through wall bore, a threaded nut mounted over such wall bore, and an adjustment screw received threadably into such threaded nut to engage the sleeve to lock such collar adjusted vertically relative to the sleeve;
a horizontal table support plate mounted on such collar and formed with a central bore for passage of the sleeve;
a horizontal table top carried on its forward extremity from a horizontal surface on the vehicle and projecting rearwardly and a substantially horizontal plane and formed in its rear extremity with a through bore for passage of the sleeve;
bolts projecting through the table and the holes in the support plate to mount the tabletop to the support plate.

12. Trailer hitch mounted table and umbrella support apparatus for mounting from a vehicle with a trailer hitch receiver and comprising:
a square female tube received at its forward extremity in the receiver and being open at its rear end;
a square male tube received telescopically into said rear end and projecting rearwardly to terminate in a free end;
a tubular mounting device including a vertical open ended umbrella sleeve for slidable receipt of an umbrella post and a female collar received slidably over the upper end of the umbrella post;
an adjuster interposed between the umbrella sleeve and the collar for adjusting the height of the collar on the umbrella sleeve;
a table support plate mounted on the collar; and
a table top mounted at its forward extremity from the vehicle and at its rearward extremity for the plate.

13. The support apparatus of claim 12 from a trailer hitch receiver in a form of a rearwardly square tube wherein:
the forward extremity of the female tube is received telescopically into the receiver to be supported against lateral movement; and
the male tube is received in the female tube to be supported against lateral movement.

14. The support apparatus of claim 12 wherein:
the table top is at least 3 feet long.

15. The support apparatus of claim 12 wherein:
the table top is formed with a main bore for receipt there through of the upper extremity of the sleeve.

16. The support apparatus of claim 12 wherein:
the table top is formed at its rear extremity with a main bore;
the sleeve is constructed to project upwardly through the main bore;
the female collar is formed with a cylindrical wall having a through adjuster bore; and
the adjuster includes a screw received through the adjuster bore.
